(19) United States
(12) Patent Application Publication
(10) Pub. No.: US 2024/0220825 A1
(43) Pub. Date: Jul. 4, 2024

(54) MACHINE-LEARNING TECHNIQUES FOR PREDICTING ACTIONS AND BEHAVIOR

(71) Applicant: Iterable, Inc., San Francisco, CA (US)

(72) Inventors: Ayush AGARWAL, San Francisco, CA (US); Ankit AWASTHI, San Francisco, CA (US); Ilya BRIN, Bronx, NY (US); Sinead CHEUNG, San Francisco, CA (US); Michelle CHUANG, San Francisco, CA (US); Rachael CREAGER, San Francisco, CA (US); Jonathan ENG, Alameda, CA (US); Theo FERGUSON, Brooklyn, NY (US); Keyur GABANI, Fremont, CA (US); Athena LIU, Eastvale, CA (US); Jasmine LIU, San Diego, CA (US); Steven LY, San Francisco, CA (US); Nicholas MA, Kansas City, MO (US); Praateek MAHAJAN, San Francisco, CA (US); Ankur MATHUR, Dublin, CA (US); Skyler ROH, Alameda, CA (US); Samuel SEGHERS, Mandeville, LA (US); Elif SEZGIN, San Jose, CA (US); Evan STRATER, Fishers, IN (US); Russell WHITE, Cottontown, TN (US)

(21) Appl. No.: 18/397,662

(22) Filed: Dec. 27, 2023

Related U.S. Application Data
(60) Provisional application No. 63/477,547, filed on Dec. 28, 2022.

(51) Int. Cl. G06N 5/022

(52) U.S. Cl. CPC G06N 5/022

(57) ABSTRACT

Techniques are disclosed for specifying a predictive goal that describes an action that a customer of an organization may take or a behavior that a customer of the organization may exhibit. A training engine receives the predictive goal from a user via a Graphical User Interface (GUI). The user specifies the predictive goal by entering one or more customizable logical or comparative statements. A training engine divides historical data into training data and testing data, selects useful and relevant features from the historical data as inputs to a machine learning model, and trains the machine learning model. The training engine transmits the trained machine learning model to an inference engine that generates, for each customer in a historical data set, a probability that the customer will satisfy the predictive goal within a specified time frame. The disclosed techniques further generate explanatory data associated with the trained machine learning model.

### CROSS-REFERENCE TO RELATED APPLICATIONS

This application claims the priority benefit of United States provisional patent application titled, “MACHINE-LEARNING TECHNIQUES FOR PREDICTING ACTIONS AND BEHAVIOR,” filed on Dec. 28, 2022, and having Ser. No. 63/477,547. The subject matter of this related application is hereby incorporated herein by reference.

### BACKGROUND

### Field of the Various Embodiments

Embodiments of the present disclosure relate generally to marketing, computer science, and machine learning, and more specifically, techniques for predicting actions and behaviors.

### Description of the Related Art

Organizations often desire to predict a likelihood that their customers will perform certain actions or exhibit certain behaviors. For example, an organization may wish to determine the likelihood that an existing customer or subset of existing customers will “churn,” i.e., discontinue using a particular product or service offered by the organization, potentially within a specified future time period. An organization may also desire to identify one or more customers who are likely to purchase products or services in a given future time period, as well as predict the volume or quantity of purchases by those customers. These predictions may provide insight into the organization's future revenue and growth potential and allow the organization to focus its customer marketing and/or retention efforts.

Existing techniques for predicting customer actions and behaviors may employ commercially available, preconfigured machine learning models. These machine learning models process historical data including customer, transaction, or organizational data and generate a specific prediction, such as the likelihood that a particular customer will churn within a future time period.

One drawback of the above technique is that the preconfigured machine learning model is limited to generating a single type of prediction, such as a churn propensity for a customer or a prediction of future order volume from a customer. Further, the preconfigured machine learning model may be constrained to process only certain types of input data that may not align with the historical data available to an organization.

Other existing techniques may require that an organization employs the services of data scientists to generate one or more customized machine learning models for predicting customer actions or behavior. Customizing a machine learning model allows the organization to tailor the model to the organization's specific requirements for both the input data available to the organization as well as the specific action or behavior to be predicted.

As with commercially available preconfigured machine learning models, a customized machine learning model may only be suitable for generating one specific type of prediction. Even customized single-goal models may be deficient in a multi-dimensional problem space and are not scalable or performant in a variety of different prediction contexts. Further, scaling or otherwise adapting preconfigured or customized models requires a data and computation infrastructure that is often unavailable or infeasible.

Another drawback of the above techniques is that preconfigured or customized machine learning models may generate a prediction without explanatory context. For instance, a machine learning model may predict a likelihood that a specific customer will complete a purchase in the future without identifying specific input features that were relevant to the machine learning model's prediction. These context-free predictions may provide an organization with limited or no insight into the relationship between historical and future customer behavior and may lessen the organization's confidence in the machine learning model's predictions.

As the foregoing illustrates, what is needed in the art are more effective techniques for predicting actions and behaviors.

### SUMMARY

One embodiment of the present invention sets forth a method for predicting actions and behaviors, the method including receiving, from a user via a graphical user interface, a plurality of prediction goal criteria for a machine learning model and generating, based on the plurality of prediction goal criteria, a prediction goal. The method further includes generating a plurality of machine learning features based on data included in a historical data set and generating, based on the plurality of machine learning features and the historical data set, a trained machine learning model. The method also includes predicting, via the trained machine learning model, a probability that the prediction goal will be satisfied within a specified time frame.

One technical advantage of the disclosed techniques relative to the prior art is that the disclosed techniques allow a user, such as an organization, to specify a prediction goal (e.g., an action or behavior for which a likelihood is to be predicted) rather than being limited to a single predefined goal, such as churn prediction or predicted sales volume. The disclosed techniques enable fine-grained control of the construction of prediction goals, allowing for a variety of goals to be defined and scaled across multiple contexts. Further, the disclosed techniques provide explanatory context associated with a generated prediction, including a subset of most relevant machine learning features and measures of their influences on the prediction. The disclosed techniques also identify subsets of relevant features whose values are most likely to increase the likelihood of a predicted action or behavior or decrease the likelihood of a predicted action or behavior. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of GUI engine 108 of FIG. 1, according to various embodiments.

FIG. 3 is a more detailed illustration of training engine 106 of FIG. 1, according to various embodiments.

FIG. 4 illustrates an example GUI training display, according to various embodiments.

FIG. 5 is a more detailed illustration of inference engine 110 of FIG. 1, according to various embodiments.

FIG. 6 illustrates an example GUI inference display, according to various embodiments.

FIG. 7 is a more detailed illustration of explanatory engine 112 of FIG. 1, according to various embodiments.

FIG. 8 illustrates an example GUI explanatory display, according to various embodiments.

FIG. 9 is a flow diagram of method steps for receiving a goal definition and training a machine learning model, according to various embodiments.

FIG. 10 is a flow diagram of method steps for generating predictions via a trained machine learning model, according to various embodiments.

FIG. 11 is a flow diagram of method steps for generating explanatory data, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### Action and Behavior Prediction Overview

A user, such as an organization, may provide a predictive goal specifying an action or a behavior to be predicted for one or more customers of the organization. The user supplies one or more comparative or logical statements, via a graphical user interface, to specify the predictive goal. A training engine validates the specified predictive goal, selects features from a dataset of historical data to provide as input features to a machine learning model, and trains the machine learning model. During inference time, an inference engine generates probabilities for each of one or more customers of the organization based on the trained machine learning model. The generated probabilities represent a likelihood that each customer will take the specified action or exhibit the specified behavior within either a specified or a default future time period. The inference engine displays the generated probabilities for the one or more customers and further displays metadata associated with the generated probabilities. The metadata may include a predictive strength for the machine learning model, an indication of a subset of the most predictive input features to the machine learning model, or a listing of the input features that are most likely to influence the generated probabilities in either a positive or negative direction.

### System Overview

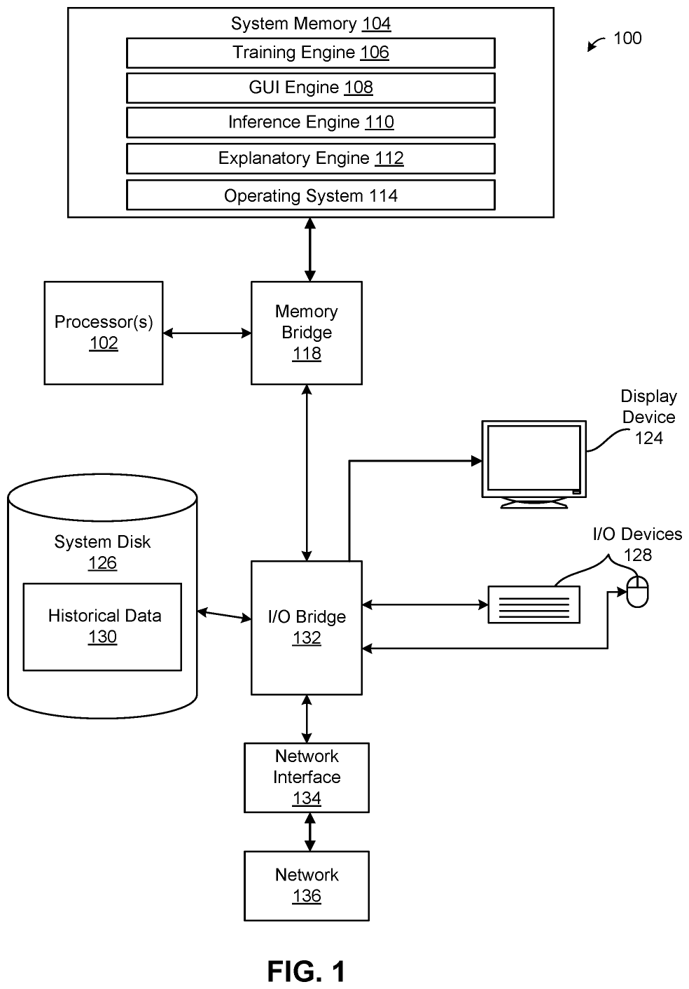

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to execute a training engine 106, a GUI engine 108, an inference engine 110, and an explanatory engine 112 that reside in a system memory 104.

It is noted that the computing device described herein is illustrative and that any other technically feasible configurations fall within the scope of the present disclosure. For example, multiple instances of training engine 106, GUI engine 108, inference engine 110, and explanatory engine 112 could execute on a set of nodes in a distributed and/or cloud computing system to implement the functionality of computing device 100. In another example, training engine 106, GUI engine 108, inference engine 110, and explanatory engine 112 could execute on various sets of hardware, types of devices, or environments to adapt training engine 106, GUI engine 108, inference engine 110, and explanatory engine 112 to different use cases or applications. In a third example, training engine 106, GUI engine 108, inference engine 110, and explanatory engine 112 could execute on different computing devices and/or different sets of computing devices.

In one embodiment, computing device 100 includes, without limitation, a memory bridge 118 that connects one or more processors 102, an input/output (I/O) bridge 132 coupled to one or more input/output (I/O) devices 128, memory 104, a system disk 126, and a network interface 134. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 128 include devices capable of providing input, such as a keyboard, a mouse, a touch-sensitive screen, and so forth, as well as devices capable of providing output, such as a display device. Additionally, I/O devices 128 may include devices capable of both receiving input and providing output, such as a touchscreen, a universal serial bus (USB) port, and so forth. I/O devices 128 may be configured to receive various types of input from an end-user of computing device 100, and to also provide various types of output to the end-user of computing device 100, such as displayed digital images or digital videos or text. In some embodiments, one or more of I/O devices 128 are configured to couple computing device 100 to a network 136. In some embodiments, a separate display device 124 may provide various types of output to the end-user of computing device 100. In various embodiments, display device 124 may include multiple display devices.

Network 136 is any technically feasible type of communications network that allows data to be exchanged between computing device 100 and external entities or devices, such as a web server or another networked computing device. For example, network 136 may include a wide area network (WAN), a local area network (LAN), a wireless (WiFi) network, and/or the Internet, among others.

System disk 126 includes non-volatile storage for applications and data, and may include fixed or removable disk drives, flash memory devices, and CD-ROM, DVD-ROM, Blu-Ray, HD-DVD, or other magnetic, optical, or solid-state storage devices. Operating system 114, training engine 106, GUI engine 108, inference engine 110, and explanatory engine 112 may be stored in system disk 126 and loaded into memory 104 when executed. System disk 126 further includes historical data 130 that stores one or more of customer, transaction, and organizational data.

System memory 104 includes a random-access memory (RAM) module, a flash memory unit, or any other type of memory unit or combination thereof. Processor(s) 102, I/O bridge 132, and network interface 134 are configured to read data from and write data to memory 104. System memory 104 includes various software programs that can be executed by processor(s) 102 and application data associated with said software programs, including training engine 106, GUI engine 108, inference engine 110, and explanatory engine 112.

In some embodiments, training engine 106 trains one or more machine learning models to perform behavior or action prediction. In some embodiments, inference engine 110 predicts future behavior and or action(s) for a customer based on specified prediction goal criteria. In some embodiments, explanatory engine 112 calculates contextual explanatory information associated with one or more predictions, and GUI engine 108 receives and transmits data via one or more graphical user interfaces.

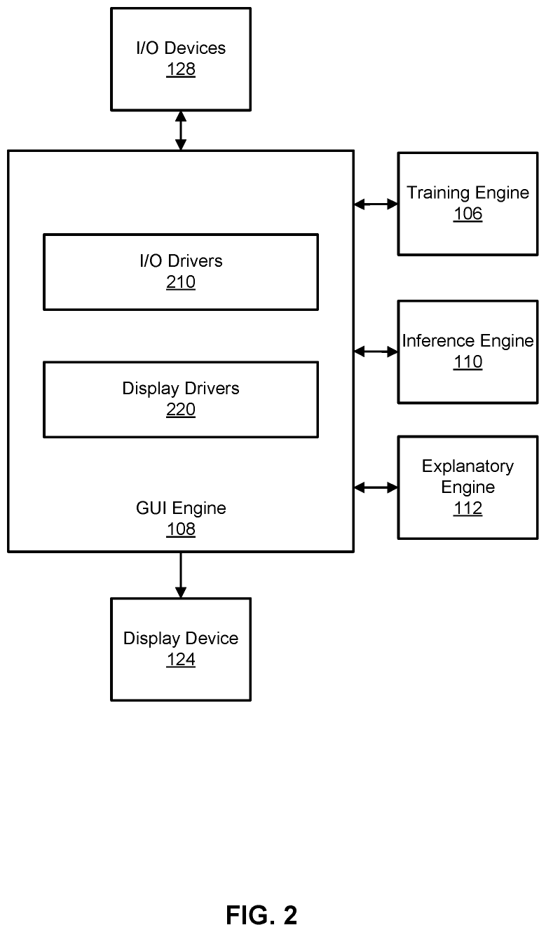

FIG. 2 is a more detailed illustration of GUI engine 108 of FIG. 1, according to various embodiments. GUI engine 108 receives input data via I/O devices 128 and generates data for display on display device 124. GUI engine 108 receives input data and generates data for display during execution of one or more of training engine 106, inference engine 110, and explanatory engine 112. As shown, GUI engine 108 includes, without limitation, I/O drivers 210 and display drivers 220. I/O drivers 210 include one or more protocols and/or data formatting definitions to facilitate data exchange with I/O devices 128. Display drivers 220 specify an interface between GUI engine 108 and display device 124.

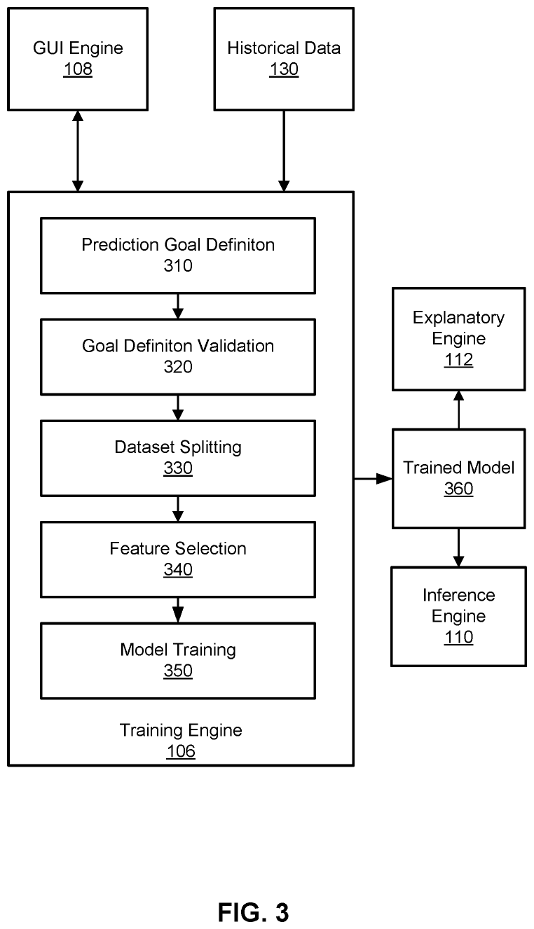

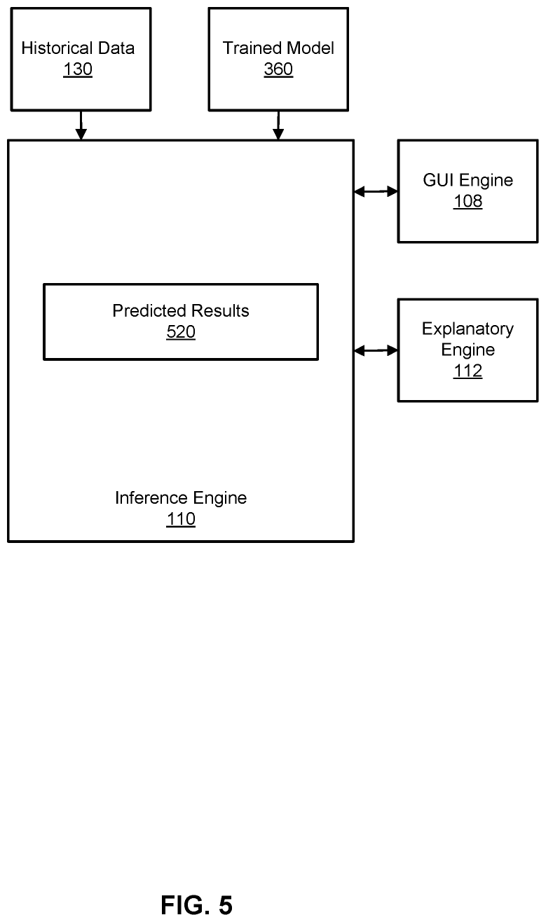

GUI engine 108 enables data input and output during the execution of training engine 106, inference engine 110, and explanatory engine 112. For example, GUI engine 108 may generate a visual display on display device 124. The visual display may prompt the user to input a prediction goal definition to training engine 106, as discussed in more detail in the description of FIG. 3 below. GUI engine 108 may further generate a display of predictions generated by inference engine 110 as discussed in more detail in the description of FIG. 5 below. GUI engine 108 may also generate a display of contextual explanatory data generated by explanatory engine 112 as discussed in more detail in the description of FIG. 5 below. Any or all of training engine 106, inference engine 110, or explanatory engine 112 may also transmit user input to GUI engine 108 during execution.

FIG. 3 is a more detailed illustration of training engine 106 of FIG. 1, according to various embodiments. Training engine 106 receives user input via GUI engine 108 and generates a prediction goal definition. Training engine 106 validates the goal definition and partitions historical data 130 into training and test sets. Training engine 106 selects features from historical data 130, where each feature is a measurable characteristic or quantity suitable as input to a machine learning model. Training engine 106 trains a machine learning model to generate predictions based on the prediction goal definition. As shown, training engine 106 includes, without limitation, prediction goal definition 310, goal definition validation 320, dataset splitting 330, feature selection 340, and model training 350. Training engine 106 generates trained model 360 and transmits trained model 360 to inference engine 110 and explanatory engine 112.

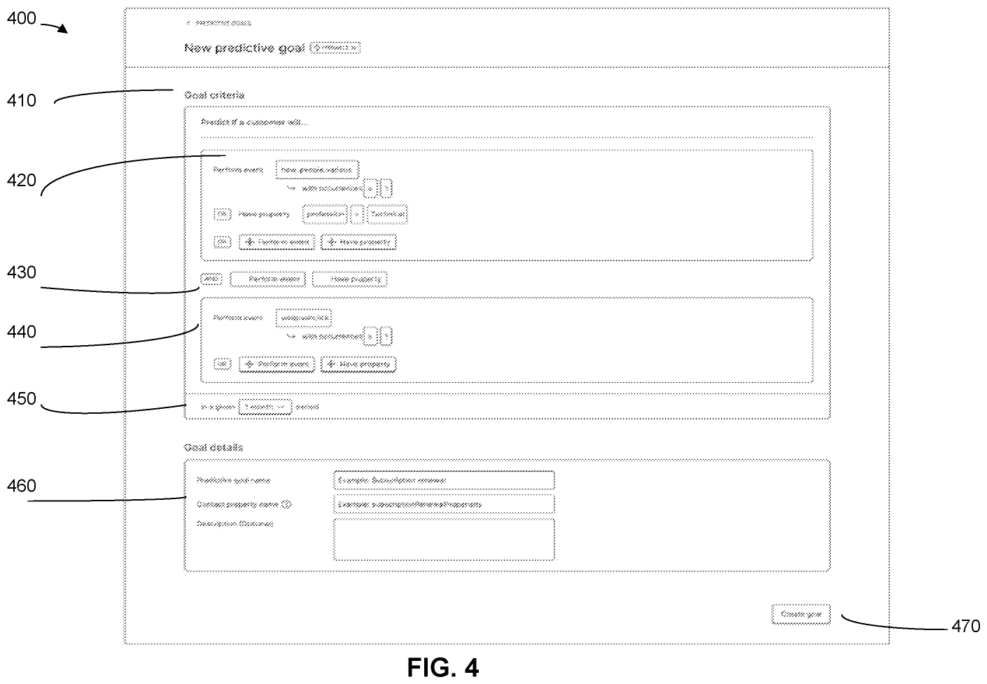

Prediction goal definition 310 generates a user-specified prediction goal based on user input and customer, transaction, and/or organization data included in historical data 130. Training engine 106 displays, via GUI engine 108, a GUI training display 400 on display device 124, where the GUI training display includes a plurality of input fields and/or selectable graphical elements. Example GUI training display 400 is discussed in more detail below in the description of FIG. 4.

Goal definition 310 presents a prediction goal starting prompt to the user, e.g., “Predict if a customer will . . . ”. Goal definition 310 receives one or more logical or comparative statements from the user further refining and defining the prediction goal. Goal definition 310 may display a statement prompt in the form of “perform an action” or “have a property.” For example, in response to a “perform an action” prompt, the user may enter “complete a purchase” or “discontinue a subscription.” In response to a “have a property” prompt, the user may enter “age is greater than 25” or “profession equals technical”. In various embodiments, user entries may be entered as free text in a text box or may be selected by the user from a drop-down menu, via radio buttons, or via any other technically feasible means. Prediction goal definition 310 may generate additional prompts in response to user selections or entries. For example, if the user selects or enters “complete a purchase” in response to a “perform an action” prompt, prediction goal definition 310 may generate an additional prompt for the user to enter a minimum value for the purchase, e.g., “at least $20” as an optional or required refinement of the user selection.

Prediction goal definition 310 may also generate logical prompts, such as “AND” or “OR.” After selecting a logical prompt, prediction goal definition 310 generates one or more additional statement prompts for user input, as discussed above. For example, after the user has selected “complete a purchase,” prediction goal definition 310 may further refine a prediction goal in response to the user subsequently selecting the “OR” logical prompt, selecting a “perform an action” prompt, and selecting “add an item to cart.” The resulting goal definition may include the limitations “Predict if a customer will” (the goal starting prompt) “complete a purchase” OR “add an item to cart.” Prediction goal definition 310 may generate any number of additional logical prompts such that the user may continue to iteratively refine the prediction goal.

In various embodiments, prediction goal definition 310 may generate a prompt for a user-specified time frame. Prediction goal definition 310 further refines the prediction goal based on the specified time frame. For example, in response to a user selection of “within 30 days,” prediction goal definition 310 may append the 30-day time frame to any other limitations of the prediction goal. In various embodiments, the time frame may be optional, or the time frame may be of a fixed duration rather than user-selectable.

Predictive goal definition 310 generates a prompt that, when selected by the user, finalizes the prediction goal. In various embodiments, predictive goal definition 310 translates the prediction goal into a textual format such as JavaScript Object Notation (JSON). Predictive goal definition 310 transmits the prediction goal to goal definition validation 320.

Goal definition validation 320 receives the prediction goal from predictive goal definition 310 and analyzes the prediction goal for structural errors. Structural errors may include a missing prediction goal, an undefined prediction time frame, or a missing element for a goal limitation. Goal definition validation may further verify that a logical operation such as an AND or OR operation contains at least two operands and is therefore structurally complete.

Goal definition validation 320 may further analyze the prediction goal for numerical errors. Numerical errors include conditions where the quantity or duration of data in historical data 130 is insufficient, given the limitations of the prediction goal. For example, goal definition validation 320 may report a numerical error if the prediction goal includes the limitation “complete a purchase of at least $100” and the customer data included in historical data 130 contains fewer than a minimum specified number of historical instances of customers completing purchases of at least $100. In various embodiments, goal definition validation 320 may further prompt the user to redefine the prediction goal to be more general, such that a greater number of customers included in historical data 130 satisfy the prediction goal. Goal definition validation 320 may report a numerical error if a percentage of customers included in historical data 130 satisfying a goal definition is greater than a predetermined threshold, e.g., 99%. In various embodiments, goal definition validation 320 may further prompt the user to redefine the prediction goal to be more specific, such that a fewer number of customers included in historical data 130 satisfy the prediction goal. Goal definition validation 320 may generate a numerical error if the prediction time frame duration is too long relative to the duration of historical data included in historical data 130. For example, if the prediction time frame is 180 days, goal definition validation 320 may generate a numerical error stating that the historical data only spans 90 days and is insufficient for a prediction time frame of 180 days. In various embodiments, goal definition validation 320 may further suggest a more suitable prediction time frame and/or prompt the user to shorten the prediction time frame. Goal definition validation 320 may also generate a numerical error if the prediction time frame duration is too long relative to the duration of specific features included in historical data 130, even if the duration of historical data 130 would otherwise be sufficient. For example, if the prediction goal includes a completed sale of a particular product and all instances of sales of that product in historical data 130 occur within a short period time relative to the length of the prediction time frame, goal definition validation 320 may generate a numerical error regardless of the total duration of the data included in historical data 130.

Goal definition validation 320 may continue to iteratively validate the prediction goal for structural and/or numerical errors as the user refines the prediction goal. Upon completion of validation, goal definition validation 320 transmits the validated goal to dataset splitting 330.

Dataset splitting 330 receives a validated prediction goal from goal definition validation 320 and divides the data included in historical data 130 into a training data set and a testing data set for training a machine learning model as described below. For the data included in historical data 130, dataset splitting 330 may receive three user-specified dates: the beginning of the training period, the end of the training period (which corresponds to the beginning of the testing period), and the end of the testing period. When determining these dates, dataset splitting 330 analyzes the durations of the resulting training and test periods and determines whether the durations are sufficiently long for the purposes of training a machine learning model based on the prediction goal. Dataset splitting 330 further determines that the training and test periods do not overlap, and that the data included in the testing period is not right-censored. In various embodiments, dataset splitting 330 may generate the dates that define the training and testing periods rather than receiving the dates as user input. Dataset splitting 330 transmits the defined training and testing periods to model training 350 discussed below.

Feature selection 340 determines a subset of features based on the data included in historical data 130. A feature is any measurable characteristic or quantity suitable for use as input to a machine learning model. In various embodiments, a feature may directly represent an item of data in historical data 130 or may be calculated or derived from one or more items of data in historical data 130. For example, a feature representing a date on which a customer subscribed to a service may be determined directly from a historical customer record in historical data 130, while a feature representing a duration during which a customer has been active may be derived by calculating a duration between two different historical customer records. Thus, a single item of data in historical data 130 may contribute to one or more features. Feature selection 340 includes a list of predefined features and associations between the features and the data included in historical data 130.

Feature selection 340 may include a heuristic feature selector. The heuristic feature selector removes features that are not available during the entire determined training period. Heuristic feature selection reduces the number of features, which reduces training time and complexity and enhances the explainability of prediction results generated by a trained machine learning model.

Feature selection 340 may also include a univariate feature selector that removes features that have a low predictive value. For each feature, feature selection 340 generates a univariate model for the feature and calculates the predictive value of the feature. The features are ranked by their predictive power and a predetermined quantity of the most predictive features are retained for training a machine learning model, while the remaining features are removed and are not used for training a machine learning model. In various embodiments, feature selection 340 may remove all but the 600 most predictive features via univariate feature selection.

Feature selection 340 may further include a correlational feature selector that removes features that are highly correlated with other features and therefore do not provide sufficient additional predictive power. Feature selection 340 iteratively selects features in a stepwise manner. At each step, feature selection 340 calculates the predictive power of each of the remaining unselected features while subtracting a maximum calculated correlation value between the unselected feature and each of the previously selected features. Feature selection 340 selects a predetermined quantity of the most predictive features that also exhibit low collinearity with the other selected features. In various embodiments, feature selection 340 may select the 300 most predictive features via correlational feature selection. Feature selection 340 transmits the selected features to model training 350.

Model training 350 trains a machine learning model based on the validated predictive goal definition generated by goal definition validation 320, features received from feature selection 340, the training and testing periods determined by dataset splitting 330, and the data included in historical data 130.

Model training 350 trains a regression model that, for each customer included in historical data 130, predicts a likelihood that the customer will satisfy the prediction goal specified in the prediction goal definition discussed above. In various embodiments, model training 350 trains the regression model via a gradient boosting technique such as gradient-boosted logistic regression trees or gradient-boosted decision trees. During training, model training 350 iteratively adjusts parameters of the regression model based on the regression model's predictions for data in historical data 130 associated with the determined training period. Model training 350 evaluates the trained regression model based on the regression model's predictions for data in historical data 130 associated with the determined testing period. After training and testing the regression model, model training 350 generates trained model 360 and transmits trained model 360 to explanatory engine 112 and inference engine 110.

FIG. 4 illustrates an example GUI training display, according to various embodiments. GUI engine 108 generates example GUI training display 400 for display to a user on display device 124 based on data received from and transmitted to training engine 106. GUI training display 400 represents a graphical display that may be presented to a user during the execution of predictive goal generation 310 as discussed above in reference to FIG. 3.

Display element 410 includes user fillable and/or selectable items allowing a user to specify prediction goal criteria. As shown, display element 410 includes a starting prompt “Predict if a customer will . . . ” Display element 410 includes display element 420, where a user may specify that the goal definition should include an event for a user to perform or a property of a user. As shown, a selected event may include a prompt for additional refinement of the event such as the pictured “with occurrences,” to which the user has entered or selected “>/1” (greater than or equal to one). Display element 420 further includes an indication that the user has selected the logical OR criteria “Have Property” specifying that “profession” is equal to “Technical.” Display element 420 also includes selectable buttons for adding additional OR logical criteria, either an event to be performed or a property of a user.

Display element 430 includes a selectable button for adding a logical AND criteria to the criteria already specified. As with logical OR criteria, logical AND criteria may include an event to be performed or a property of a user. Display element 440 represents a previously entered logical AND criteria and includes a selectable button for adding a logical OR criteria to the previously entered logical AND criteria.

Display element 450 includes a selection interface wherein a user may define a prediction goal duration. As discussed above in reference to FIG. 3, the user may make a selection via a drop-down menu as shown in display element 450, via radio buttons, or via free text entry. In various embodiments, the prediction goal duration may be fixed and GUI training display 400 may not include display element 450.

Display element 460 includes fields describing a predictive goal name, contact information, and a textual description of the goal. When the user has completed specifying the predictive goal criteria, the user may select the “Create goal” display element 470 to finalize the predictive goal definition.

FIG. 5 is a more detailed illustration of inference engine 110 of FIG. 1, according to various embodiments. For each customer included in historical data 130, inference engine 110 predicts a probability that the customer will satisfy a user-specified prediction goal within the specified prediction time frame. As shown, inference engine 110 includes predicted results 520.

Inference engine receives customer, transaction, and/or organization data from historical data 130. Inference engine 110 further receives trained model 360 from training engine 106. For each customer included in historical data 130, inference engine 110 predicts, via trained model 360, a probability that the customer will satisfy a user-specified prediction goal within the specified prediction time frame based on feature data included in historical data 130. These predicted probabilities are stored as predicted results 520. In various embodiments, inference engine 110 may further generate and store metadata associated with predicted results 520, including a quantity of customers and percentile rankings for each of the customers based on probabilities predicted for each customer. Inference engine 110 may also calculate and record statistical metadata associated with predicted results 520, such a calculated mean, median, and standard deviation for one or more of the predicted probabilities. Inference engine 110 transmits predicted results 520 to GUI engine 108 for display to a user.

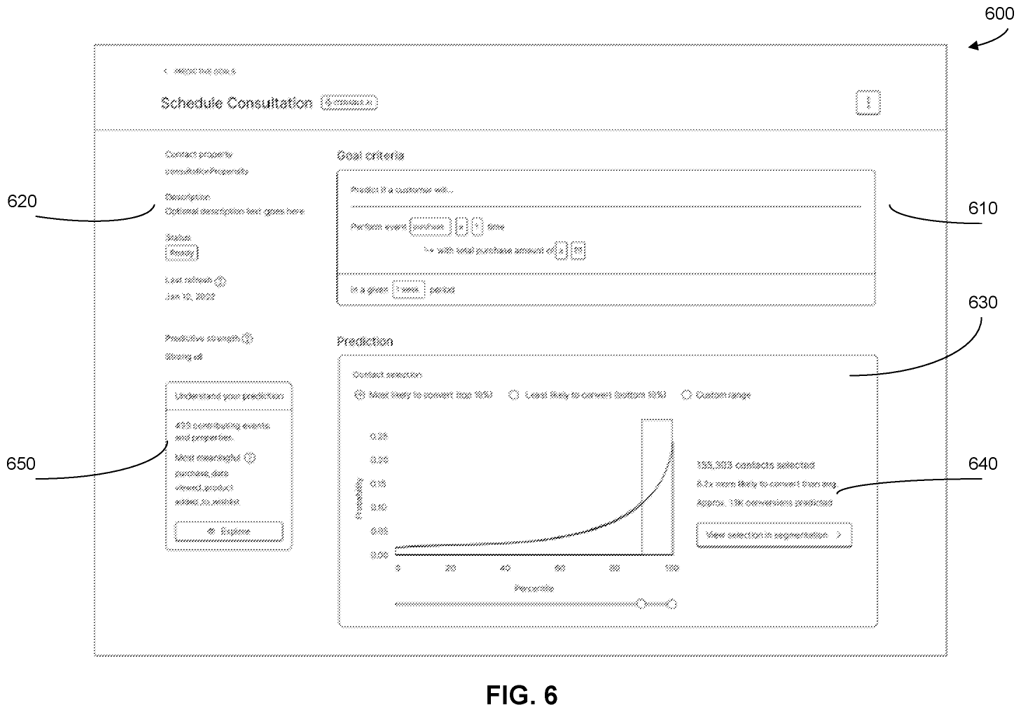

FIG. 6 illustrates an example GUI inference display, according to various embodiments. GUI engine 108 generates example GUI inference display 600 for display to a user on display device 124 based on data received from and transmitted to inference engine 110. GUI inference display 600 represents a graphical display that may be presented to a user based on predictive results 520 generated by inference engine 110 as discussed above in reference to FIG. 5.

Display element 610 includes a display of the prediction goal definition specified by the user as discussed above in reference to FIGS. 3 and 4. Display element 620 includes user-provided contact information and a user-provided textual description of the prediction goal.

Display element 630 includes a graphical depiction of predictive results 520. The graphical depiction includes data points for each customer in historical data 130, ordered from lowest predicted probability to highest predicted probability to form a curved line. The vertical axis of the graphical depiction represents the probability that the customer will satisfy the prediction goal, and the horizontal axis represents a percentile ranking for the customer. In various embodiments, display element 630 includes radio buttons for selection of a specific portion of the results, for example a selection of the customers in the bottom 10^{th} percentile or the top 10^{th} percentile. A user may also select a custom range or percentiles by selecting the appropriate radio button and adjusting sliders depicted below the graphical depiction in display element 630.

Display element 640 includes additional information for a segment of customers selected from the graphical depiction. For example, display element 640 may include a quantity of customers selected and an indication of the relative probability that the selected customers will satisfy the prediction goal compared to an average probability calculated for all of the customers. Display element 640 may also include a prediction of how many of the selected customers will satisfy the prediction goal. In various embodiments, display element 640 may include a user-selectable “View selection in segmentation” feature that generates a GUI segmentation display (not shown). The GUI segmentation display allows the user to further filter the selected customers by specifying one or more additional feature criteria.

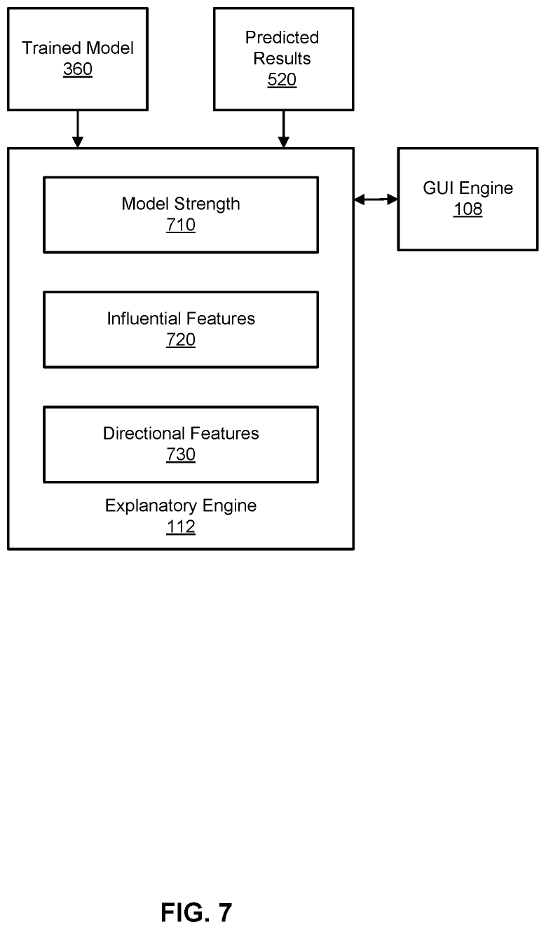

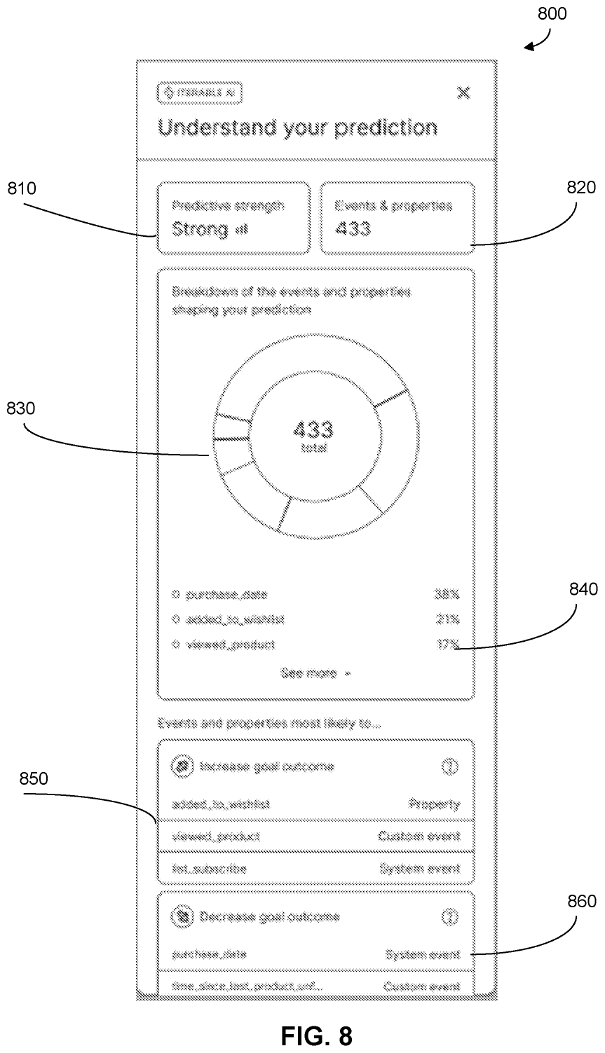

Display element 650 includes elements of explanatory information regarding predicted results 520. As shown, display element 650 may include a quantity of “contributing events and properties” (i.e., machine learning features) chosen for trained model 360 in feature selection 340 as discussed above in reference to FIG. 3. Display element 650 may further include a listing of one or more “most meaningful” features e.g., one or more machine learning features with the highest predictive power as discussed above in reference to FIG. 3. The explanatory information included in display element 650 may be a subset of all available explanatory information. Explanatory information is discussed in greater detail below in the descriptions of FIGS. 7 and 8.

FIG. 7 is a more detailed illustration of explanatory engine 112 of FIG. 1, according to various embodiments. Explanatory engine 112 generates contextual and explanatory information associated with trained model 360 and predicted results 520. As shown, explanatory engine 112 includes model strength 710, influential features 720, and directional features 730.

Explanatory engine 112 receives trained model 360 from training engine 106 and predicted results 520 from inference engine 110. Model strength 710 calculates a predictive strength for trained model 360. In various embodiments, predictive strength may be a quantitative value such as lift quality, based on the relative performance of trained model 360 compared to predictions made without a trained model (e.g., predictions based on a single predicted probability). Explanatory engine 112 may further convert multiple ranges of a quantitative value into multiple qualitative values describing the model strength, such as “strong,” “acceptable,” and “weak.”

Explanatory engine 112 determines influential features 720 based on the machine learning features included in trained model 360. From the machine learning features included in trained model 360, explanatory engine 112 selects one or more of the features having the highest predictive values as discussed above in reference to FIG. 3. From the features having the highest predictive values, explanatory engine 112 combines multiple features that were derived from a single event or property in historical data 130 and generates a list of the resulting most influential events and/or properties. In various embodiments, explanatory engine 112 may select one or more of the features having predictive values greater than a predetermined threshold and thus having at least a threshold influence on the plurality of predictions.

Explanatory engine 112 further determines directional features 730. Directional features have values taken from a continuous or non-continuous range of values, such that comparisons between directional feature values include an indication of relative directionality. For instance, prices of various homes may vary from “lower” to “higher,” and the ages of a group of people may vary from “younger” to “older”. Explanatory engine 112 generates a list of one or more events or properties in historical data 130 for which an increase in a feature value associated with the event or property would most increase a customer's probability of satisfying the prediction goal. As discussed above with reference to FIG. 3, training engine 106 may generate multiple machine learning features based on a single event or property included in historical data 130. In various embodiments, explanatory engine 112 may combine the relevance of the multiple machine learning features and include the property or event in the list, rather than the individual machine learning features. Explanatory engine 112 further generates a list of one or more events or properties in historical data 130 for which an increase in a feature value associated with the event or property would most decrease a customer's probability of satisfying the prediction goal. Explanatory engine 112 transmits model strength 710 and the event/property lists to GUI engine 108 for display to a user.

FIG. 8 illustrates an example GUI explanatory display, according to various embodiments. GUI engine 108 generates example GUI explanatory display 800 for display to a user on display device 124 based on data received from and transmitted to explanatory engine 112. GUI explanatory display 800 represents a graphical display that may be presented to a user based on model strength 710, influential features 720, and direction features 730 generated by explanatory engine 112 as discussed above in reference to FIG. 7.

Display element 810 includes an indication of the predictive strength of trained model 360. As discussed above in reference to FIG. 7, model strength may be represented with a qualitative label such as “Strong,” as shown in display element 810. Display element 810 may further include a strength icon depicting vertical bars of increasing height, analogous to a signal strength indication on a cellular phone. In various embodiments, display element 810 may alternatively or additionally include a quantitative indication of predictive strength, such as a lift quality value for the model as discussed above in reference to FIG. 7.

Display element 820 includes a quantity of events and properties from historical data 130 that are either included as machine learning features in trained model 360 or from which training engine 106 derived one or more machine learning features. Display element 830 also includes the quantity of events and properties and a circular chart including sections indicating the relative influence of one or more of the events and/or properties.

Display element 840 includes a list of one or more most influential events and properties from historical data 130 as discussed above in reference to FIG. 7. Display elements 850 and 860 include lists of events and properties in historical data 130 for which an increase in a value associated with the event or property would most increase or decrease the likelihood of a user satisfying the goal definition, respectively.

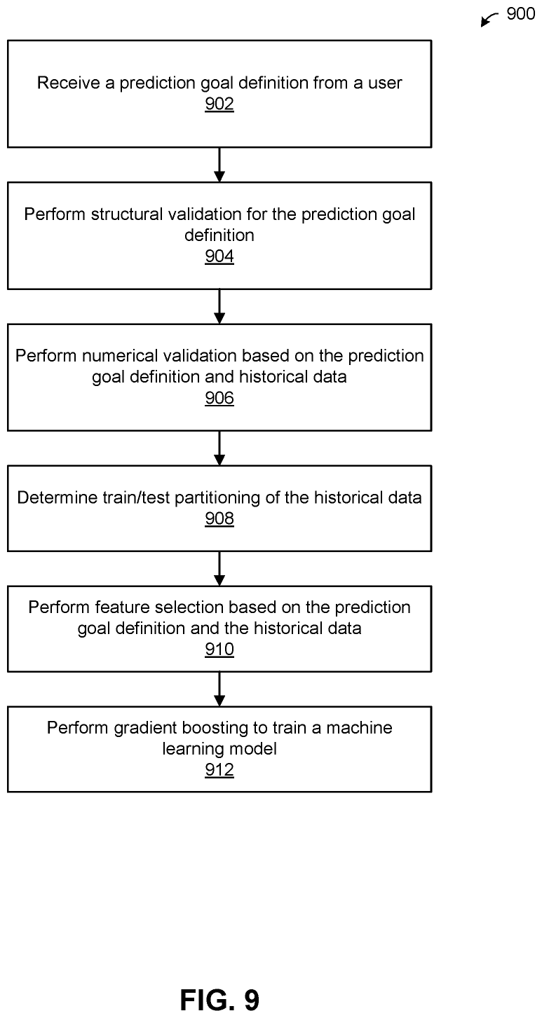

FIG. 9 is a flow diagram 900 of method steps for receiving a goal definition and training a machine learning model, according to various embodiments. Although the method steps are described in conjunction with the systems and displays of FIGS. 1-4, persons skilled in the art will understand that any system configured to perform the method steps in any order falls within the scope of the present disclosure.

As shown, in operation 902, training engine 106 receives a prediction goal definition from a user. Training engine 106 presents to the user, via GUI engine 108, one or more graphical displays including user fillable and/or selectable elements. The user may specify one or more prediction goal criteria via the graphical display. Training engine 106 presents a starting prompt to the user e.g., “Predict if a customer will . . . ”, and the user specifies one or more prediction goal criteria, such as an event to be performed or a property of a user. The user may specify one or more criteria, and may specify logical relationships between criteria with logical AND or OR operators. In various embodiments, the user may specify a prediction time frame for the prediction goal, or the time frame may be fixed.

In operation 904, training engine 106 analyzes the specified prediction goal and determines if the prediction goal includes one or more structural errors. Structural errors may include a missing or incomplete prediction goal, a missing operand for a logical AND or OR operation, or a missing time frame. Training engine 106 may iteratively analyze the prediction goal and prompt the user with suggestions to resolve detected structural errors.

In operation 906, training engine 106 analyzes the specified prediction goal to detect numerical errors based on the prediction goal definition and historical data 130. Numerical errors may include an overly broad prediction goal which greater than a specified percentage of customers included in historical data 130 would satisfy. Numerical errors may also include an overly specific prediction goal that would be satisfied by fewer than a specified quantity of customers included in historical data 130. Numerical errors may further include a specified time frame that is too long, or one or more goal definition criteria for which there is insufficient data in historical data 130.

In operation 908, training engine 106 determines a partitioning of historical data 130 into training data and testing data. Specifically, training engine 106 determines starting and ending dates for a training period and a testing period, and partitions the data in historical data 130 based on those starting and ending dates. In various embodiments, the starting and ending dates may be specified by a user or may be generated by training engine 106. Training engine 106 determines whether the training and testing periods are sufficiently long and do not overlap, and that the data is not right-censored during the testing period.

In operation 910, training engine 106 selects features for training a machine learning model, based on the predictive goal definition and historical data 130. Training engine 106 executes a heuristic feature selector that removes features that are not present in historical data 130 for the entire training period determined in operation 908. Training engine 106 further executes a univariate feature selector that removes features that have poor predictive power for the specified goal definition. Training engine 106 generates a univariate model for each feature and keeps the features with the highest predictive powers as determined by their respective univariate models. Training engine 106 also executes a correlational feature selector that removes features whose predictive powers are highly correlated with the predictive powers of previously selected features, as selecting an additional feature that is highly correlated with previously selected features does not significantly improve the performance of the model.

In operation 912, training engine 106 trains a regression model that, for each customer included in historical data 130, predicts a likelihood that the customer will satisfy the prediction goal specified in the prediction goal definition discussed above. In various embodiments, training engine 106 trains the regression model via a gradient boosting technique such as gradient-boosted regression trees or gradient-boosted decision trees. During training, training engine 106 iteratively adjusts parameters of the regression model based on the regression model's predictions for data in historical data 130 associated with the determined training period. Training engine 106 evaluates the trained regression model based on the regression model's predictions for data in historical data 130 associated with the determined testing period. After training and testing the regression model, model training 350 generates trained model 360.

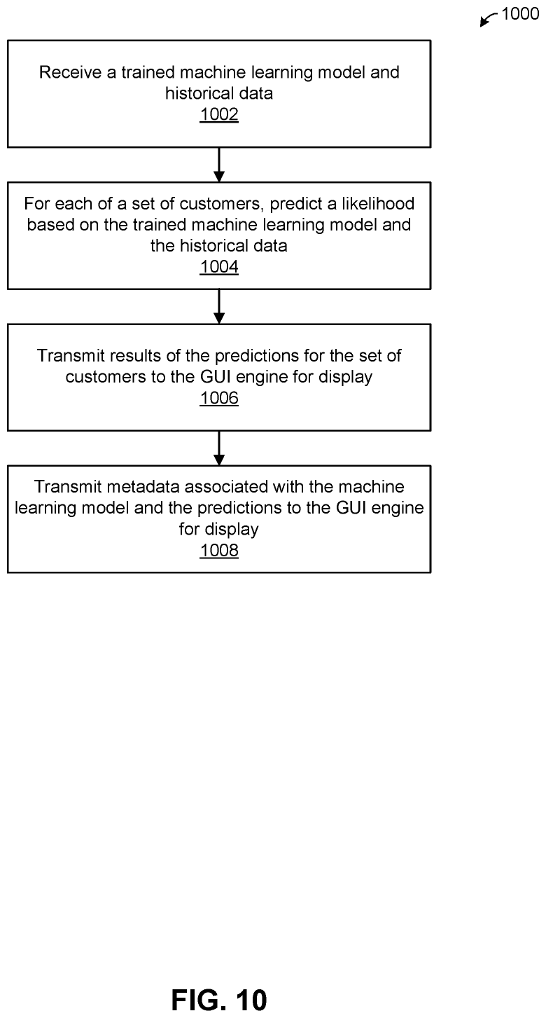

FIG. 10 is a flow diagram 1000 of method steps for generating predictions via a trained machine learning model, according to various embodiments. Although the method steps are described in conjunction with the systems and displays of FIGS. 1-2 and 5-6, persons skilled in the art will understand that any system configured to perform the method steps in any order falls within the scope of the present disclosure.

As shown, in operation 1002, inference engine 110 receives trained model 360 and historical data 130. In operation 1004, inference engine 110 generates, for each customer included in historical data 130, a probability that the customer will satisfy the user-specified goal definition within a specified time frame. These predicted probabilities are stored as predicted results 520. Inference engine 110 may further generate and store metadata associated with predicted results 520, including a quantity of customers and percentile rankings for each of the customers based on probabilities predicted for each customer. Inference engine 110 may also calculate and record statistical metadata associated with predicted results 520, such a calculated mean, median, and standard deviation for one or more of the predicted probabilities.

In operation 1006, inference engine 110 transmits predicted results 520 to GUI engine 108 for display to a user. In operation 1008, inference engine 110 transmits metadata associated with predicted results 520 to GUI engine 108 for display to a user.

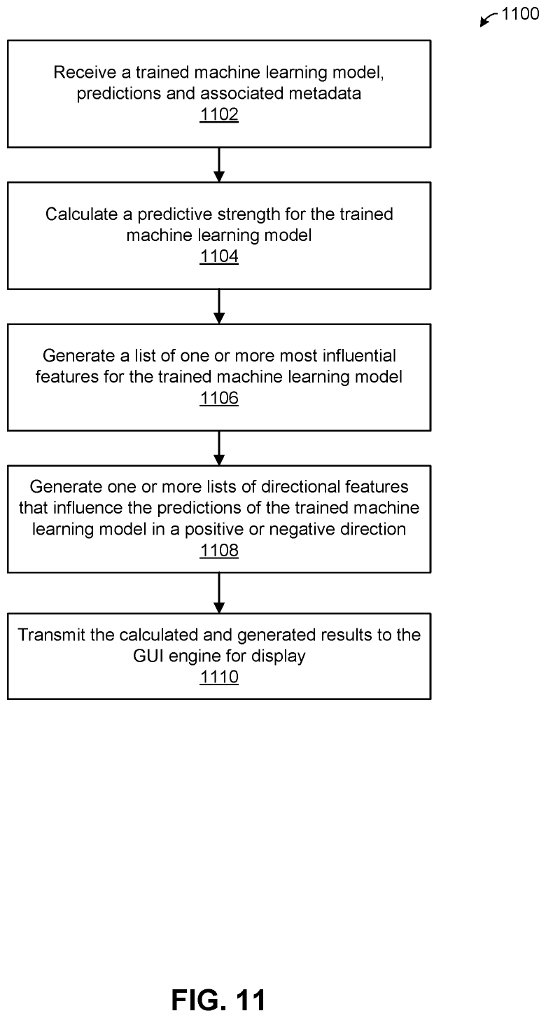

FIG. 11 is a flow diagram 1100 of method steps for generating explanatory data, according to various embodiments. Although the method steps are described in conjunction with the systems and displays of FIGS. 1-2 and 7-8, persons skilled in the art will understand that any system configured to perform the method steps in any order falls within the scope of the present disclosure.

As shown, in operation 1102, explanatory engine 112 receives trained model 360 from training engine 106 and predicted results 520 and associated metadata from inference engine 110.

In operation 1104, explanatory engine 112 calculates a predictive strength for trained model 360. In various embodiments, predictive strength may be a quantitative value, such as lift quality. Explanatory engine 112 may further convert multiple ranges of a quantitative value into multiple qualitative values describing the model strength, such as “strong,” “acceptable,” and “weak.”

In operation 1106, explanatory engine 112 determines influential features for trained model 360. From the machine learning features included in trained model 360, explanatory engine 112 selects one or more of the features having the highest predictive values as discussed above in reference to FIG. 3. In various embodiments, explanatory engine 112 may combine multiple features that were derived from a single event or property in historical data 130 and generate a list of the resulting most influential events and/or properties.

In operation 1108, explanatory engine 112 further determines directional features 730. Directional features have values taken from a continuous or non-continuous range of values, such that comparisons between directional feature values include an indication of relative directionality. Explanatory engine 112 generates a list of one or more events or properties in historical data 130 for which an increase in a value associated with the event or property would most increase a customer's probability of satisfying the prediction goal. Explanatory engine 112 further generates a list of one or more events or properties in historical data 130 for which an increase in a value associated with the event or property would most decrease a customer's probability of satisfying the prediction goal.

In operation 1110, explanatory engine 112 transmits the calculated model strength and the generated event/property lists to GUI engine 108 for display to a user.

In sum, a user, such as an organization, may specify a predictive goal that describes an action that a customer of the organization may take or a behavior that a customer of the organization may exhibit. A training engine receives the predictive goal from the user via a Graphical User Interface (GUI) engine. The user specifies the predictive goal by entering one or more customizable logical or comparative statements. For instance, the user may specify a predictive goal of “customer will make a purchase in excess of $20 in the next 30 days” given the additional conditions that “the customer has made purchases in the past” and “the customer has been inactive for more than one month.” The training engine validates the predictive goal, ensuring both that the goal is completely and correctly formed and that there is a sufficient quantity and duration of historical data to train a machine learning model. The training engine divides the historical data into training data and testing data, selects useful and relevant features from the historical data as inputs to a machine learning model, and trains the machine learning model. The training engine transmits the trained machine learning model to an inference engine.

The inference engine receives the trained machine learning model from the training engine, as well as all or a portion of the historical data. Based on the trained machine learning model and the historical data, the inference engine calculates, for each of one or more customers included in the historical data, a probability that the customer will perform the action or exhibit the behavior specified in the predictive goal within either a specified or a default future time period. The inference engine transmits the prediction results based on the calculated probabilities to the GUI engine for display. For example, the GUI engine may display, for a subset of customers, the number of customers in the subset and how the calculated probabilities associated with the subset of customers compare with the calculated probabilities for all customers. The prediction results may further include metadata associated with the prediction results or the trained machine learning model. An explanatory engine may also calculate a predictive strength of the trained machine learning model, a list of the most predictive machine learning model input features, or a list of the specific features most likely to influence a predicted probability for a customer, either in a positive or a negative direction. The explanatory engine may present the metadata and calculated feature lists to the user via the GUI engine.

One technical advantage of the disclosed techniques relative to the prior art is that the disclosed techniques allow a user such as an organization to specify a prediction goal (e.g., an action or behavior for which a likelihood is to be predicted) rather than being limited to a single predefined goal, such as churn prediction or predicted sales volume. The disclosed techniques enable fine-grained control of the construction of prediction goals, allowing for a variety of goals to be defined and scaled across multiple contexts. Further, the disclosed techniques provide explanatory context associated with a generated prediction, including a subset of most relevant machine learning features for the prediction. The disclosed techniques also identify subsets of relevant features whose values are most likely to increase the likelihood of a predicted action or behavior or decrease the likelihood of a predicted action or behavior. These technical advantages represent one or more technological improvements over prior art approaches.
1. In some embodiments, a computer-implemented method for predicting actions and behaviors comprises receiving, from a user via a graphical user interface, a plurality of prediction goal criteria for a machine learning model, generating, based on the plurality of prediction goal criteria, a prediction goal, generating a plurality of machine learning features based on data included in a historical data set, generating, based on the plurality of machine learning features and the historical data set, a trained machine learning model, and predicting, via the trained machine learning model, a probability that the prediction goal will be satisfied within a specified time frame.
2. The computer-implemented method of clause 1, wherein each of the plurality of prediction goal criteria includes at least one of an event or a property to be predicted.
3. The computer-implemented method of clauses 1 or 2, wherein two or more of the plurality of prediction goal criteria are included as operands in a logical operation.
4. The computer-implemented method of any of clauses 1-3, further comprising partitioning, via a training engine, the historical data set into data associated with a training time period and data associated with a testing time period, determining, via the training engine, that the training time period and the testing time period do not overlap in time, determining, via the training engine and based on the specified time frame, that the data associated with the testing time period is not right-censored, determining, via the training engine and based on the specified time frame, that a duration associated with the training time period is longer than a first predetermined threshold, and determining, via the training engine and based on the specified time frame, that a duration associated with the testing time period is longer than a second predetermined threshold.
5. The computer-implemented method of any of clauses 1-4, wherein generating the plurality of machine learning features further comprises calculating, via a training engine, a predictive strength for each of one or more machine learning features, and selecting, via the training engine, at least one of the one or more machine learning features for inclusion in the plurality of machine learning features based on the predictive strength.
6. The computer-implemented method of any of clauses 1-5, wherein generating the plurality of machine learning features further comprises calculating, via a training engine, a correlation value between two or more machine learning features, and selecting, via the training engine, at least one of the one or more machine learning features for inclusion in the plurality of machine learning features based on the correlation value.
7. The computer-implemented method of any of clauses 1-6, wherein the historical data set includes at least one of customer data, transaction data, and organizational data.
8. In some embodiments, one or more non-transitory computer-readable media store instructions that, when executed by one or more processors, cause the one or more processors to perform the steps of receiving, from a user via a graphical user interface, a plurality of prediction goal criteria for a machine learning model, generating, based on the plurality of prediction goal criteria, a prediction goal, generating a plurality of machine learning features based on data included in a historical data set, generating, based on the plurality of machine learning features and the historical data set, a trained machine learning model, and predicting, via the trained machine learning model, a probability that the prediction goal will be satisfied within a specified time frame.
9. The one or more non-transitory computer-readable media of clause 8, wherein each of the plurality of prediction goal criteria includes at least one of an event or a property to be predicted.
10. The one or more non-transitory computer-readable media of clauses 8 or 9, wherein two or more of the plurality of prediction goal criteria are included as operands in a logical operation.
11. The one or more non-transitory computer-readable media of any of clauses 8-10, wherein the instructions further cause the one or more processors to perform the steps of partitioning, via a training engine, the historical data set into data associated with a training time period and data associated with a testing time period, determining, via the training engine, that the training time period and the testing time period do not overlap in time, determining, via the training engine and based on the specified time frame, that the data associated with the testing time period is not right-censored, determining, via the training engine and based on the specified time frame, that a duration associated with the training time period is longer than a first predetermined threshold, and determining, via the training engine and based on the specified time frame, that a duration associated with the testing time period is longer than a second predetermined threshold.
12. The one or more non-transitory computer-readable media of any of clauses 8-11, wherein the instructions, when generating the plurality of machine learning features, further cause the one or more processors to perform the steps of calculating, via a training engine, a predictive strength for each of one or more machine learning features, and selecting, via the training engine, at least one of the one or more machine learning features for inclusion in the plurality of machine learning features based on the predictive strength.
13. The one or more non-transitory computer-readable media of any of clauses 8-12, wherein the instructions, when generating the plurality of machine learning features, further cause the one or more processors to perform the steps of calculating, via a training engine, a correlation value between two or more machine learning features, and selecting, via the training engine, at least one of the one or more machine learning features for inclusion in the plurality of machine learning features based on the correlation value.
14. The one or more non-transitory computer-readable media of any of clauses 8-13, wherein the historical data set includes at least one of customer data, transaction data, and organizational data.
15. In some embodiments, a system comprises one or more memories storing instructions, and one or more processors for executing the instructions to receive, from a user via a graphical user interface, a plurality of prediction goal criteria for a machine learning model, generate, based on the plurality of prediction goal criteria, a prediction goal, generate a plurality of machine learning features based on data included in a historical data set, generate, based on the plurality of machine learning features and the historical data set, a trained machine learning model, and predict, via the trained machine learning model, a probability that the prediction goal will be satisfied within a specified time frame.
16. The system of clause 15, wherein each of the plurality of prediction goal criteria includes at least one of an event or a property to be predicted.
17. The system of clauses 15 or 16, wherein two or more of the plurality of prediction goal criteria are included as operands in a logical operation.
18. The system of any of clauses 15-17, wherein the one or more processors further execute the instructions to partition, via a training engine, the historical data set into data associated with a training time period and data associated with a testing time period, determine, via the training engine, that the training time period and the testing time period do not overlap in time, determine, via the training engine and based on the specified time frame, that the data associated with the testing time period is not right-censored, determine, via the training engine and based on the specified time frame, that a duration associated with the training time period is longer than a first predetermined threshold, and determine, via the training engine and based on the specified time frame, that a duration associated with the testing time period is longer than a second predetermined threshold.
19. The system of any of clauses 15-18, wherein the one or more processors, when generating the plurality of machine learning features, further execute the instructions to calculate, via a training engine, a predictive strength for each of one or more machine learning features, and select, via the training engine, at least one of the one or more machine learning features for inclusion in the plurality of machine learning features based on the predictive strength.
20. The system of any of clauses 15-19, wherein the one or more processors, when generating the plurality of machine learning features, further execute the instructions to calculate, via a training engine, a correlation value between two or more machine learning features, and select, via the training engine, at least one of the one or more machine learning features for inclusion in the plurality of machine learning features based on the correlation value.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for predicting actions and behaviors, the method comprising:
receiving, from a user via a graphical user interface, a plurality of prediction goal criteria for a machine learning model;
generating, based on the plurality of prediction goal criteria, a prediction goal;
generating a plurality of machine learning features based on data included in a historical data set;
generating, based on the plurality of machine learning features and the historical data set, a trained machine learning model; and
predicting, via the trained machine learning model, a probability that the prediction goal will be satisfied within a specified time frame.

2. The computer-implemented method of claim 1, wherein each of the plurality of prediction goal criteria includes at least one of an event or a property to be predicted.

3. The computer-implemented method of claim 1, wherein two or more of the plurality of prediction goal criteria are included as operands in a logical operation.

4. The computer-implemented method of claim 1, further comprising:
partitioning, via a training engine, the historical data set into data associated with a training time period and data associated with a testing time period;
determining, via the training engine, that the training time period and the testing time period do not overlap in time;
determining, via the training engine and based on the specified time frame, that the data associated with the testing time period is not right-censored;
determining, via the training engine and based on the specified time frame, that a duration associated with the training time period is longer than a first predetermined threshold; and
determining, via the training engine and based on the specified time frame, that a duration associated with the testing time period is longer than a second predetermined threshold.

5. The computer-implemented method of claim 1, wherein generating the plurality of machine learning features further comprises:
calculating, via a training engine, a predictive strength for each of one or more machine learning features; and
selecting, via the training engine, at least one of the one or more machine learning features for inclusion in the plurality of machine learning features based on the predictive strength.

6. The computer-implemented method of claim 1, wherein generating the plurality of machine learning features further comprises:
calculating, via a training engine, a correlation value between two or more machine learning features; and
selecting, via the training engine, at least one of the one or more machine learning features for inclusion in the plurality of machine learning features based on the correlation value.

7. The computer-implemented method of claim 1, wherein the historical data set includes at least one of customer data, transaction data, and organizational data.

8. One or more non-transitory computer-readable media storing instructions that, when executed by one or more processors, cause the one or more processors to perform the steps of:
receiving, from a user via a graphical user interface, a plurality of prediction goal criteria for a machine learning model;
generating, based on the plurality of prediction goal criteria, a prediction goal;
generating a plurality of machine learning features based on data included in a historical data set;
generating, based on the plurality of machine learning features and the historical data set, a trained machine learning model; and
predicting, via the trained machine learning model, a probability that the prediction goal will be satisfied within a specified time frame.

9. The one or more non-transitory computer-readable media of claim 8, wherein each of the plurality of prediction goal criteria includes at least one of an event or a property to be predicted.

10. The one or more non-transitory computer-readable media of claim 8, wherein two or more of the plurality of prediction goal criteria are included as operands in a logical operation.

11. The one or more non-transitory computer-readable media of claim 8, wherein the instructions further cause the one or more processors to perform the steps of:
partitioning, via a training engine, the historical data set into data associated with a training time period and data associated with a testing time period;
determining, via the training engine, that the training time period and the testing time period do not overlap in time;
determining, via the training engine and based on the specified time frame, that the data associated with the testing time period is not right-censored;
determining, via the training engine and based on the specified time frame, that a duration associated with the training time period is longer than a first predetermined threshold; and
determining, via the training engine and based on the specified time frame, that a duration associated with the testing time period is longer than a second predetermined threshold.

12. The one or more non-transitory computer-readable media of claim 8, wherein the instructions, when generating the plurality of machine learning features, further cause the one or more processors to perform the steps of:
calculating, via a training engine, a predictive strength for each of one or more machine learning features; and
selecting, via the training engine, at least one of the one or more machine learning features for inclusion in the plurality of machine learning features based on the predictive strength.

13. The one or more non-transitory computer-readable media of claim 8, wherein the instructions, when generating the plurality of machine learning features, further cause the one or more processors to perform the steps of:
calculating, via a training engine, a correlation value between two or more machine learning features; and
selecting, via the training engine, at least one of the one or more machine learning features for inclusion in the plurality of machine learning features based on the correlation value.

14. The one or more non-transitory computer-readable media of claim 8, wherein the historical data set includes at least one of customer data, transaction data, and organizational data.

15. A system comprising:
one or more memories storing instructions; and
one or more processors for executing the instructions to:
receive, from a user via a graphical user interface, a plurality of prediction goal criteria for a machine learning model;
generate, based on the plurality of prediction goal criteria, a prediction goal;
generate a plurality of machine learning features based on data included in a historical data set;
generate, based on the plurality of machine learning features and the historical data set, a trained machine learning model; and
predict, via the trained machine learning model, a probability that the prediction goal will be satisfied within a specified time frame.

16. The system of claim 15, wherein each of the plurality of prediction goal criteria includes at least one of an event or a property to be predicted.

17. The system of claim 15, wherein two or more of the plurality of prediction goal criteria are included as operands in a logical operation.

18. The system of claim 15, wherein the one or more processors further execute the instructions to:
partition, via a training engine, the historical data set into data associated with a training time period and data associated with a testing time period;
determine, via the training engine, that the training time period and the testing time period do not overlap in time;
determine, via the training engine and based on the specified time frame, that the data associated with the testing time period is not right-censored;
determine, via the training engine and based on the specified time frame, that a duration associated with the training time period is longer than a first predetermined threshold; and
determine, via the training engine and based on the specified time frame, that a duration associated with the testing time period is longer than a second predetermined threshold.

19. The system of claim 15, wherein the one or more processors, when generating the plurality of machine learning features, further execute the instructions to:
calculate, via a training engine, a predictive strength for each of one or more machine learning features; and
select, via the training engine, at least one of the one or more machine learning features for inclusion in the plurality of machine learning features based on the predictive strength.

20. The system of claim 15, wherein the one or more processors, when generating the plurality of machine learning features, further execute the instructions to:
calculate, via a training engine, a correlation value between two or more machine learning features; and
select, via the training engine, at least one of the one or more machine learning features for inclusion in the plurality of machine learning features based on the correlation value.
